(19) United States
(12) Patent Application Publication
(10) Pub. No.: US 2016/0255573 A1
(43) Pub. Date: Sep. 1, 2016

(54) ACCESS POINT, STATION, AND ACCESS CONFIGURATION METHOD BETWEEN ACCESS POINT AND STATION

(71) Applicant: INTELLECTUAL DISCOVERY CO., LTD., Seoul (KR)

(72) Inventors: Ju Hyung SON, Uiwang-si (KR); Jin Sam KWAK, Uiwang-si (KR); Hyun Oh OH, Gwacheon-si (KR)

(73) Assignee: INTELLECTUAL DISCOVERY CO., LTD., Seoul (KR)

(21) Appl. No.: 15/151,988

(22) Filed: May 11, 2016

Related U.S. Application Data
(63) Continuation of application No. PCT/KR2014/010736, filed on Nov. 10, 2014.

(30) Foreign Application Priority Data
Nov. 11, 2013 (KR) 10-2013-0136089
Mar. 31, 2014 (KR) 10-2014-0038287

(51) Int. Cl. H04W 48/16; H04W 48/02

(52) U.S. Cl. CPC H04W 48/16; H04W 48/02; H04W 88/08

(57) ABSTRACT

An access configuration method between an access point and a station in accordance with an exemplary embodiment of the present disclosure includes: transmitting a communication configuration message to one or more stations by the access point; and performing access configuration by the access point according to an access request of the station. Herein, the communication configuration message includes information on an access priority requirement of each station.

### CROSS-REFERENCE TO RELATED APPLICATION

This application is a continuation application of PCT Application No. PCT/KR2014/010736 filed on Nov. 10, 2014, which claims the benefit of Korean Patent Application No. 10-2013-0136089 filed on Nov. 11, 2013 and Korean Patent Application No. 10-2014-0038287 filed on Mar. 31, 2014, the entire disclosures of which are incorporated herein by reference.

### TECHNICAL FIELD

The present disclosure relates to an access configuration method between an access point and a station.

### BACKGROUND

With the wide spread of mobile devices in recent years, a wireless LAN technology capable of providing fast wireless Internet services to such mobile devices has been attracting a lot of attention. The wireless LAN technology enables mobile devices, such as smart phones, smart pads, laptop computers, mobile multimedia players, and embedded devices, to be wirelessly connected to the Internet in a close distance.

The initial wireless LAN technology supported a speed of 1 Mbps to 2 Mbps by frequency hopping, spread spectrum, infrared ray communication, and the like using a frequency of 2.4 GHz through the Institute of Electrical and Electronics Engineers (IEEE) 802.11. Recently, the wireless LAN technology can support a speed of maximum 54 Mbps by applying orthogonal frequency division multiplex (OFDM). Besides, IEEE 802.11 is commercializing or developing standards for various technologies such as improvement of quality for service (QoS), access point (AP) protocol compatibility, security enhancement, radio resource measurement, wireless access vehicular environment, fast roaming, mesh network, interworking with an external network, and wireless network management.

Of IEEE 802.11, IEEE 802.11b supports a communication speed of maximum 11 Mbps by using a frequency of a 2.4 GHz band. IEEE 802.11a, which has been commercially used after IEEE 802.11b, reduced an influence of interference, as compared with the frequency of the significantly complicated 2.4 GHz band, by using a frequency of a 5 GHz band, instead of the 2.4 GHz band, and also improved the communication speed up to maximum 54 Mbps by using the OFDM technology. However, IEEE 802.11a has a drawback in that its communication distance is shorter than IEEE 802.11b. In addition, IEEE 802.11g has attracted a lot of attention since it realizes the communication speed of maximum 54 Mbps by using the frequency of the 2.4 GHz band like IEEE 802.11b, and satisfies backward compatibility. In terms of the communication distance, IEEE 802.11g is also superior to IEEE 802.11a.

Further, IEEE 802.11n was established as a technology standard to overcome the limit of the communication speed that has been considered as a weakness of the wireless LAN. The purpose of IEEE 802.11n is to increase a speed and reliability of a network and expand an operation distance of a wireless network. More specifically, IEEE 802.11n supports a high throughput (HT) with a data processing speed of maximum 540 Mbps or more, and is based on the multiple inputs and multiple outputs (MIMO) technology using multiple antennas in both ends of each of transmission and reception units in order to minimize transmission errors and optimize a data speed. Furthermore, this standard may use a coding method that transmits several overlapping copies in order to improve data reliability, or orthogonal frequency division multiplex (OFDM) in order to increase a speed.

As supply of the wireless LAN increases and applications using the wireless LAN are diversified, there has been recently an increasing need for a new wireless LAN system to support a higher throughput (very high throughput; VHT) than the data processing speed supported by IEEE 802.11n. Particularly, IEEE 802.11ac supports a broad bandwidth (80 MHz to 160 MHz) in the 5 GHz frequency. The IEEE 802.11ac standard is defined only for the 5 GHz band, but initial 11ac chipsets may also support the operation in the 2.4 GHz band for lower compatibility with existing 2.4 GHz-band products. In this case, 802.11ac supports a bandwidth of from 2.4 GHz to maximum 40 MHz. Theoretically, according to this standard, a wireless LAN speed of multiple devices can be at least 1 Gbps and a maximum single link speed can be at least 500 Mbps. This is realized by expanding wireless interface concepts, such as a broader radio frequency bandwidth (maximum 160 MHz), more MIMO spatial streams (maximum 8 streams), multiple user MIMO, and high-density modification (maximum 256 QAM), accepted in 802.11n. Further, there is IEEE 802.11ad, which transmits data by using a 60 GHz band, instead of existing 2.5 GHz/5 GHz. IEEE 802.11ad is a transmission standard for providing a speed of maximum 7 Gbps by using a beamforming technology, and suitable for high bit-rate video streaming such as large-scale data or uncompressed HD videos. However, the 60 GHz frequency band is disadvantageous in that it cannot easily pass through obstacles, and thus, can be used only for devices in a short-distance space.

Meanwhile, Korean Patent No. 0643766 (entitled “Fast handover method optimized for IEEE 802.11 network”) describes a process of classifying APs on the basis of signal strength of neighboring APs and determining an AP to implement a handover on the basis of a result of the classification.

### DISCLOSURE OF THE INVENTION

### Problems to be Solved by the Invention

The present disclosure is provided to solve the above-described problems of the prior art, and provides an access configuration method, which is capable of setting access timing between access points and stations to be distributed.

### Means for Solving the Problems

According to a first aspect of the present disclosure, an access configuration method between an access point and a station includes: transmitting a communication configuration message to one or more stations by the access point; and performing an access configuration by the access point in response to an access request of the station having received the communication configuration message. Herein, the communication configuration message includes information on an access priority requirement of each station.

Further, according to a second aspect of the present disclosure, an access configuration method between an access point and a station includes: receiving a communication configuration message transmitted from the access point by the station; reading out information on a priority requirement of the station included in the communication configuration message; and requesting an access to the access point according to the information on the priority requirement of the station.

Furthermore, according to a third aspect of the present disclosure, an access point device includes: a memory that stores a program for performing an access configuration with respect to a station; one or more communication interface cards; and a processor that executes the program stored in the memory. Herein, when the program is executed, the processor transmits a communication configuration message to one or more stations and performs an access configuration in response to an access request of the station, and the communication configuration message includes information on an access priority requirement of each station.

Moreover, according to a fourth aspect of the present disclosure, a station device includes: a memory that stores a program for performing an access configuration with respect to an access point; one or more communication interface cards; and a processor that executes the program stored in the memory. Herein, when the program is executed, the processor receives a communication configuration message transmitted from the access point, reads out information on a priority requirement of a station included in the communication configuration message, and requests an access to the access point according to the information on the priority requirement of the station.

### Effects of the Invention

According to exemplary embodiments of the present disclosure, it is possible to reduce a time required for link setup when wireless communication is conducted. Particularly, in accordance with the exemplary embodiments, it is possible to provide an efficient wireless link setup method, by which stations having received link setup congestion information distribute and implement link setup requests.

The present disclosure can be used for various communication devices such as stations using wireless LAN and stations using cellular communication.

### BRIEF DESCRIPTION OF THE DRAWINGS

FIG. 1 illustrates a wireless LAN system in accordance with an exemplary embodiment;

FIG. 2 illustrates independent BSS, which is a wireless LAN system in accordance with another exemplary embodiment;

FIG. 3 is a block diagram illustrating a configuration of a station in accordance with an exemplary embodiment;

FIG. 4 is a block diagram illustrating a configuration of an AP in accordance with an exemplary embodiment;

FIG. 5 schematically illustrates a process of setting up a link between a STA in accordance with an exemplary embodiment with an AP;

FIG. 6 illustrates a passive scanning method of a STA in accordance with an exemplary embodiment;

FIG. 7 illustrates an active scanning method of a STA in accordance with an exemplary embodiment;

FIG. 8 is a diagram provided to explain information on an access priority requirement corresponding to an exemplary embodiment;

FIG. 9 shows a structure of a beacon message periodically transmitted to STAs by an AP in accordance with an exemplary embodiment;

FIG. 10 shows a structure of a probe request message that requests an access to an AP in order for STAs to access the AP;

FIG. 11 shows a structure of a probe response message transmitted by an AP having received a probe request message in accordance with an exemplary embodiment;

FIG. 12 is a flowchart illustrating a process of an access between an STA and an AP in accordance with an exemplary embodiment;

FIG. 13 shows an internal layer structure of a STA in accordance with an exemplary embodiment;

FIG. 14 illustrates a passive scanning process in accordance with an exemplary embodiment;

FIG. 15 illustrates an active scanning process in accordance with an exemplary embodiment;

FIG. 16 shows a process of scanning between an AP and a STA each including multiple network interface card modules in accordance with an exemplary embodiment; and

FIG. 17 shows a process of an access between an AP and a STA in accordance with an exemplary embodiment.

### MODE FOR CARRYING OUT THE INVENTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

FIG. 1 illustrates a wireless LAN system in accordance with an exemplary embodiment.

The wireless LAN system includes one or more basic service sets (BSSs), which indicate a group of devices that can be successfully synchronized to communicate with one another. In general, a BSS may be classified into an infrastructure BSS and an independent BSS (IBSS), and FIG. 1 shows an infrastructure BSS.

As illustrated in FIG. 1, the infrastructure BSSs BSS1 and BSS2 include one or more stations STA-1, STA-2, STA-3, STA-4 and STA-5, access points PCP/AP-1 and PCP/AP-2, which are stations providing a distribution service, and a distribution system DS for connecting the multiple access points PCP/AP-1 and PCP/AP-2.

The station (STA) is a device including a medium access control (MAC) following the regulations of the IEEE 802.11 standard and a physical layer interface for a wireless medium, and includes an access point (AP) and a non-access point STA (Non-AP station) in a broad sense. The STA for wireless communication includes a processor and a transceiver, and may further include a user interface unit, a display unit and the like in some exemplary embodiments. The processor produces a frame to be transmitted through a wireless network or processes a frame received through the wireless network, and implements various processes for controlling the STA. The transceiver is functionally connected to the processor and transmits and receives a frame for the STA through the wireless network.

The access point (AP) is an entity providing an access to the distribution system (DS) via a wireless medium for a STA connected to the AP. It is the principle that in the infrastructure BSS, communication between STAs is conducted via an AP. However, direct communication between Non-AP STAs, which aren't connected to AP, is possible if a direct link is set up. Meanwhile, in the present disclosure, the AP has a concept to include a personal BSS coordination point (PCP), and may have a concept to include any intensive controller, base station (BS), node-B, base transceiver system (BTS), or site controller in a broad sense.

Multiple infrastructures BSSs may be connected to one another through the distribution system (DS). In this case, the multiple BBSs connected to one another through the DS are referred to as an “extended service set (ESS)”. STAs included in the ESS can communicate with one another, and Non-AP STAs within the same ESS may move from one BSS into another BSS while seamlessly communicating with one another.

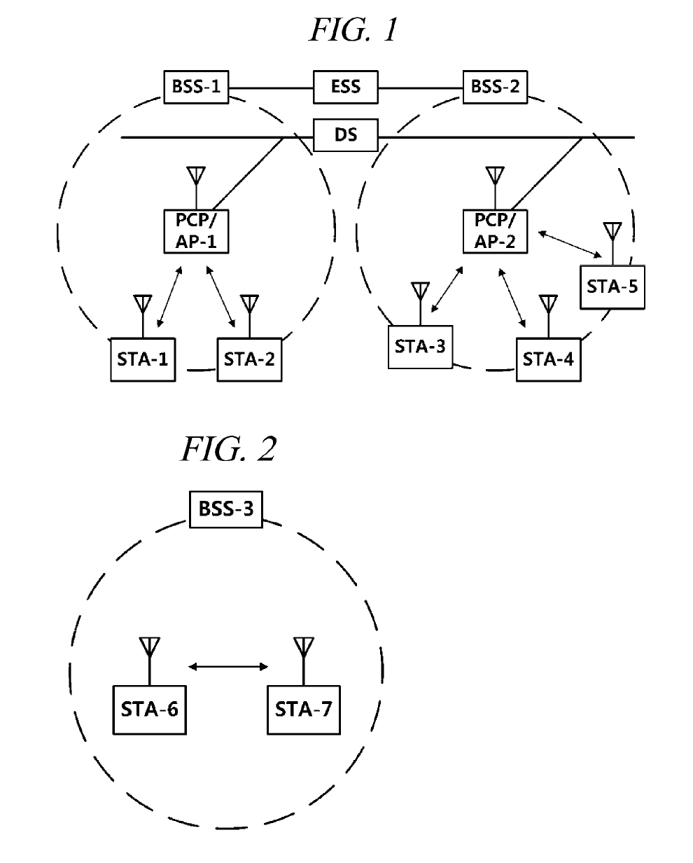

FIG. 2 illustrates independent BSS, which is a wireless LAN system in accordance with another exemplary embodiment. The redundant descriptions of the parts in the exemplary embodiment of FIG. 2, which are identical or correspond to those of FIG. 1, will be omitted.

BSS-3 illustrated in FIG. 2 is an independent BSS and does not include an AP. Thus, all stations STA-6 and STA-7 are Non-AP STAs. The independent BSS is not allowed to access the DS, and establishes a self-contained network. In the independent BSS, the stations STA-6 and STA-7 may be directly connected to each other.

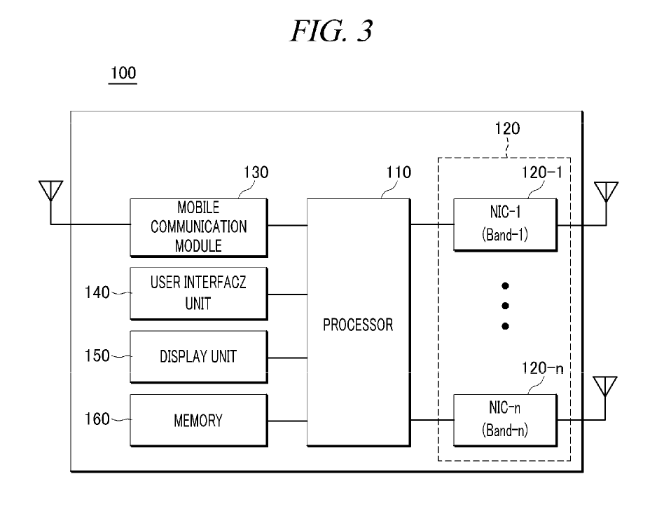

FIG. 3 is a block diagram illustrating a configuration of a station in accordance with an exemplary embodiment.

As illustrated, a STA 100 in accordance with an exemplary embodiment may include a processor 110, one or more network interface cards (NIC) 120, a mobile communication module 130, a user interface unit 140, a display unit 150, and a memory 160.

First, the NIC 120 is a module for implementing wireless LAN connection and may be provided inside or outside the STA 100. In accordance with an exemplary embodiment, the NIC 120 may include multiple NIC modules 120_1 to 120_n respectively using different frequency bands. For example, the NIC modules 120_1 to 120_n may include NIC modules using different frequency bands of 2.4 GHz, 5 GHz, 60 GHz, and the like. In accordance with an exemplary embodiment, the STA 100 may be provided with at least one NIC module using a frequency band of 6 GHz or more and at least one NIC module using a frequency band of 6 GHz or less. Each of the NIC modules 120_1 to 120_n may conduct wireless communication with an AP or an external STA according to a wireless LAN standard of the frequency band supported by the corresponding NIC module 120_1 to 120_n. The NIC 120 may operate only one NIC module 120_1 to 120_n at once or the multiple NIC modules 120_1 to 120_n at the same time depending on performance and demand of the STA 100.

Meanwhile, in the block diagram of FIG. 3, the multiple NIC modules 120_1 to 120_n of the STA 100 are illustrated as being separated from one another and a MAC/PHY layer of each of the NIC modules 120_1 to 120_n is independently operated. However, the present disclosure is not limited thereto, and the multiple NIC modules of different frequency bands may be provided as an integrated chip in the STA 100.

Further, the mobile communication module 130 transmits and receives a wireless signal with at least one of a base station, an external device, and a server by using a mobile communication network. Herein, the wireless signal may include data in various forms such as a voice call signal, a video calling call signal, or a text/multimedia message.

Furthermore, the user interface unit 140 includes various input/output means provided in the STA 100. That is, the user interface unit 140 may receive user's input by using the various input means, and the processor 110 may control the STA 100 based on the received user input. Further, the user interface unit 140 may perform output based on an instruction of the processor 110 by using the various output means.

Moreover, the display unit 150 outputs an image on a display screen. The display unit 150 may output various display objects such as contents executed by the processor 110 or user interface based on a control instruction of the processor 110.

In addition, the memory 160 stores a control program to be used in the STA 100 and various data relevant thereto. This control program may include an access program necessary to enable the STA 100 to implement an access to an AP or an external STA.

The processor 110 of the present disclosure may execute various instructions or programs, and also process data in the STA 100. Further, the processor 110 may control the above-described units of the STA 100 and data transmission and reception between the units. In accordance with an exemplary embodiment, the processor 110 controls a communication operation of the STA 100 such as sector sweep signal transmission/reception and feedback signal transmission/reception in response thereto.

In addition, the processor 110 executes a program for executing an access to an AP as stored in the memory 160, to receive a communication configuration message transmitted by the AP, read out information on a priority requirement for the STA 100 included in the communication configuration message, and request an access to the AP according to the information on the priority requirement for the STA 100. Details thereof will be described later.

FIG. 3 illustrates a block diagram of the STA 100 in accordance with an exemplary embodiment, and the separately indicated blocks are intended to logically discriminate the elements of the device. Accordingly, the above-described elements of the device may be mounted as one chip or multiple chips depending on a design of the device. Further, in an exemplary embodiment, some of the components of the STA 100, e.g., the mobile communication module 130, the user interface unit 140, and the display unit 150, may be selectively provided in the STA 100.

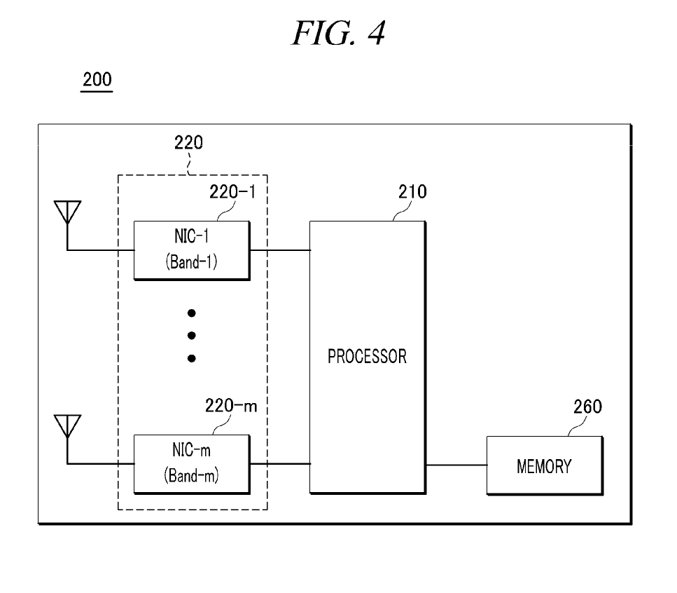

FIG. 4 is a block diagram illustrating a configuration of an AP in accordance with an exemplary embodiment.

As illustrated, the AP 200 in accordance with an exemplary embodiment may include a processor 210, a network interface card (NIC) 220, and a memory 260. The redundant descriptions of the parts of the AP 200 in the exemplary embodiment of FIG. 4, which are identical or correspond to those of the STA 100 in FIG. 3, will be omitted.

Referring to FIG. 4, the AP 200 in accordance with an exemplary embodiment includes the NIC 220 for operating a BSS in at least one frequency band. As described in the exemplary embodiment illustrated in FIG. 3, the NIC 220 of the AP 200 may also include multiple NIC modules 220_1 to 220_m respectively using different frequency bands. That is, the AP 200 in accordance with an exemplary embodiment may include NIC modules respectively using different frequency bands, e.g., two or more frequency bands of 2.4 GHz, 5 GHz, and 60 GHz. Desirably, the AP 200 may include at least one NIC module using a frequency band of 6 GHz or more and at least one NIC module using a frequency band of 6 GHz or less. Each of the NIC modules 220_1 to 220_m may conduct wireless communication with a STA according to a wireless LAN standard of the frequency band supported by the corresponding NIC module 220_1 to 220_m. The NIC 220 may operate only one NIC module 220_1 to 220_m at once or the multiple NIC modules 220_1 to 220_m at the same time depending on performance and demand of the AP 200.

Then, the memory 260 stores a control program to be used in the AP 200 and various data relevant thereto. This control program may include an access program that manages an access of a STA. Further, the processor 210 may control the units of the AP 200 and data transmission and reception between the units.

In addition, the processor 210 executes a program for executing an access to a station as stored in the memory 260, to transmit a communication configuration message to one or more STAs 100, and implement an access configuration according to access requests of STAs 100, and the communication configuration message includes information on an access priority requirement for each of the stations. Details thereof will be described later.

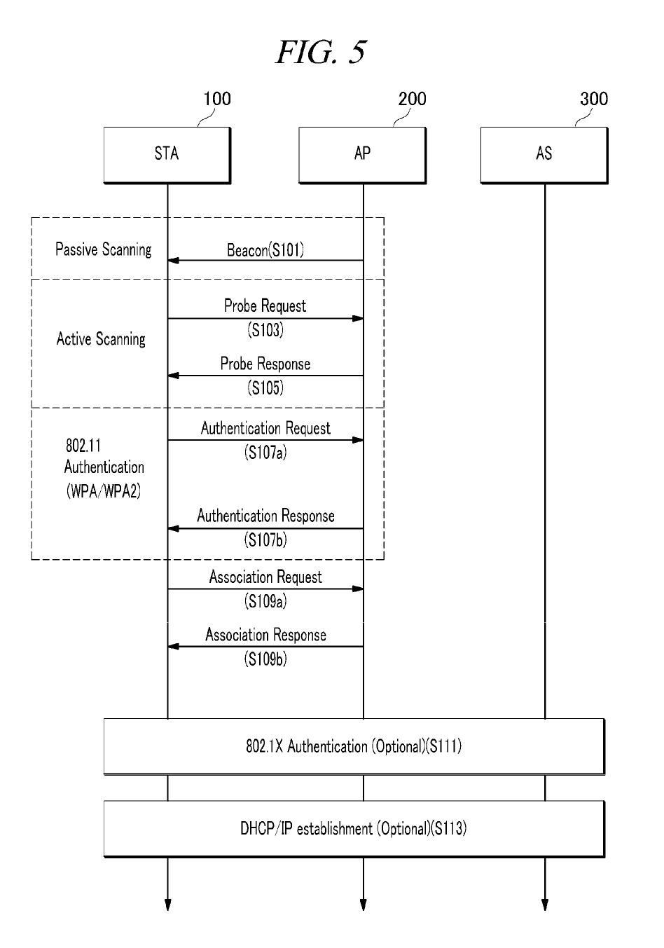

FIG. 5 schematically illustrates a process of setting up a link between a STA in accordance with an exemplary embodiment with an AP.

Referring to FIG. 5, a process, in which the STA 100 in accordance with an exemplary embodiment accesses the AP 200, is divided largely into three (3) processes: scanning, authentication, and association. The scanning process enables the STA 100 to acquire access information of the BBS operated by AP 200. Examples of a method for implementing the scanning include a passive scanning technique of acquiring information only by using a beacon message periodically transmitted by an AP (S101) and an active scanning technique of acquiring access information in the manner that an STA transmits a probe request to an AP (S103) and receives a probe response from the AP (S105).

The STA 100 that has successfully received the wireless access information in the scanning process implements the authentication process by transmitting an authentication request (S107a) and receiving an authentication response (S107b).

After the successful implementation of the authentication process in the IEEE 802.11 layer, association processes (S109a, S109b) are implemented, and authentication based on 802.1X (S111) and acquisition of an IP address through DHCP (S113) may be further implemented.

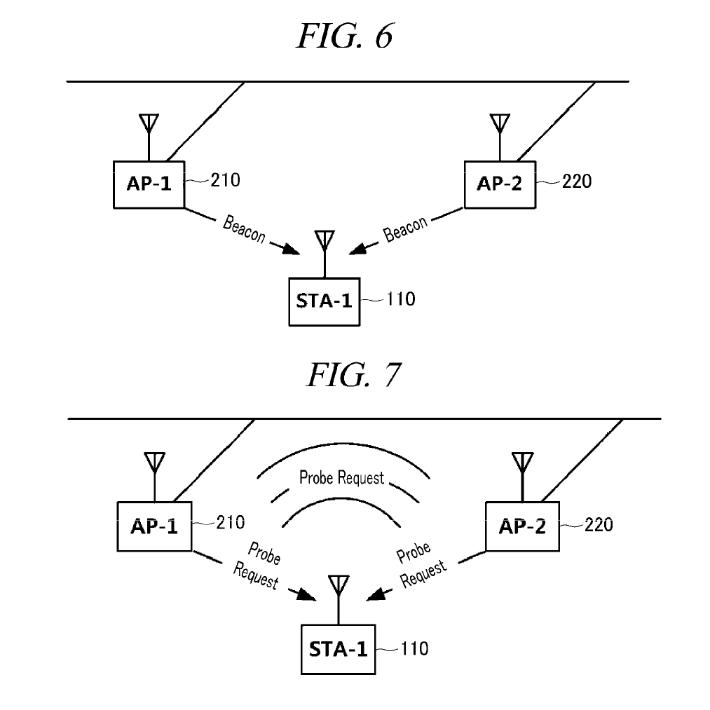

FIG. 6 illustrates a passive scanning method of a STA in accordance with an exemplary embodiment.

Referring to FIG. 6, a first STA 110 in accordance with an exemplary embodiment receives a beacon message periodically transmitted by neighboring first AP 210 and second AP 220 to acquire wireless access information of each of the APs.

FIG. 7 illustrates an active scanning method of an STA in accordance with an exemplary embodiment.

Referring to FIG. 7, the first STA 110 in accordance with an exemplary embodiment transmits a probe request message to acquire access information of neighboring APs and receives a probe response message in response thereto from each of a first AP 210 and a second AP 220 to acquire wireless access information of each of the APs.

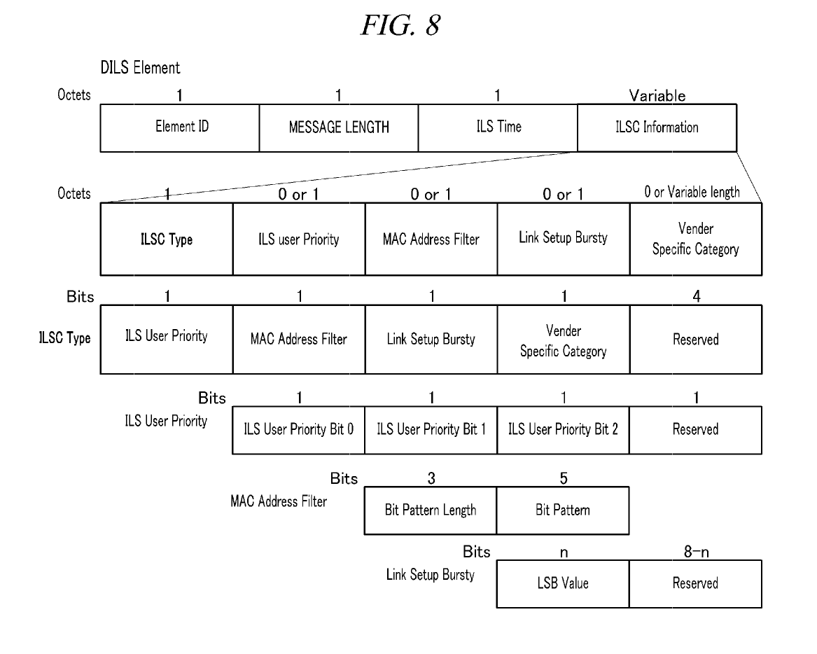

FIG. 8 is a diagram provided to explain information on an access priority requirement corresponding to an exemplary embodiment.

Access priority requirement information is intended to distribute access timing of STAs with respect to an AP and may be defined as differentiated initial link setup (DILS) information. In the present disclosure, the DILS information has an effect of distributing access timing of multiple STAs when the STAs access an AP.

The DILS information may include identifier information (Element ID), message length information, access time information (ILS Time), and initial link setup category (ILSC) information.

The identifier information indicates a sole identifier of the DILS information, the message length information means a size of a whole message, and the access time information indicates access time permitted for an STA. The initial link setup category information includes information on requirements for STAs allowable for access. An STA, which meets the requirements specified in the initial link setup category information, may attempt access for the time specified in the access time information, and an STA, which does not meet the requirements, may attempt access after the access time information is terminated.

Of the access priority requirements, the initial link setup category information may include ILSC type information (ILSC type), user priority information (ILS User Priority), hardware identifier information of a station (MAC address filter), and vendor-specific access allowance information (Vendor Specific Category). In addition, the initial link setup category information may further include link setup information (Unk Setup Bursty), which indicates a combined state of information or information about a priority of information.

At least one of the requirements may be set, and whether each of the requirements is set may be identified from whether its corresponding bit map in ILSC type information (ILSC Type) is set to 1.

If the user priority information of the ILSC type information is set to 1, the user priority information in the DILS information may exist in a size of 1 byte. For example, the user priority information in the DILS information may be indicated by a first bit (ILS User Priority Bit 0), a second bit (ILS User Priority Bit 1) and a third bit (ILS User Priority Bit 2) within 1 byte. In this case, an AP sets certain bits of the first to third bits to 1 according to a priority of an STA allowable for access. If an STA attempting an access receives the DILS information, in which a transmission priority of a frame stored in a transmission buffer of the STA and a user priority bit matching with the transmission priority are set to 1, the STA is allowable for access.

For example, in the user priority information, a priority may be interpreted to be the highest in the case where the first bit is set to 1, followed by the case where the second bit is set to 1, and the case where the third bit is set to 1. In this case, if the first bit of the user priority information included in the DILS information is set to 1, an STA attempting to transmit frames of high 4 to 7 transmission priorities of a total of 0 to 7 frame transmission priorities meets the user priority requirement. If the second bit of the user priority information included in the DILS information is set to 1, an STA attempting to transmit frames of low 0 to 3 priorities meets the user priority requirement. If the third bit of the user priority information included in the DILS information is set to 1, an STA having no frames to be transmitted meets the user priority requirement. As described above, since an STA, which meets the requirement matching with the user priority information included in the DILS information, attempts an access according to the priority, distribution of STA's access can be induced.

If the station hardware identifier information (MAC Address Filter) of the ILSC type information is set to 1, the station hardware identifier information (MAC Address Filter) within the DILS information may exist in a size of 1 byte. Such station hardware identifier information includes MAC address requirements for STAs allowable for access to an AP.

If the vendor-specific access allowance information (Vendor Specific Category) of the ILSC type information is set to 1, the vendor-specific access allowance information (Vendor Specific Category) within the DILS information may exist in a size of 1 byte or a certain byte. The vendor-specific access allowance information (Vendor Specific Category) includes requirements for STAs allowable for access, which are separately defined by STA vendors.

If the link setup information (Link Setup Bursty) of the ILSC type information is set to 1, the link setup information within the DILS information may exist in a size of 1 byte.

In accordance with an exemplary embodiment, for example, the link setup information of the ILSC type information may indicate a combined state of the user priority information, the station hardware identifier information, and the vendor-specific access allowance information, or the requirements corresponding to a priority of the information.

For example, if the link setup information is set to 0, only STAs, which meet all the user priority information, the station hardware identifier information, and the vendor-specific access allowance information, may attempt an access for an allowable access time (ILS Time).

In accordance with another exemplary embodiment, the link setup information may indicate a combined state of the requirements in more detail. For example, through each bit of 1 octet link setup information, it may be possible to indicate application of a combination, which necessarily meets the user priority information and additionally meets the station hardware identifier information or the vendor-specific access allowance information.

In accordance with yet another exemplary embodiment, a priority of the vendor-specific access allowance information may be set to be the highest, followed by a priority of the user priority information, and a priority of the station hardware identifier information. Since the requirement corresponding to the vendor-specific access allowance information grants a priority to a specific station according to a demand of a vendor who has provided the corresponding AP, the vendor-specific access allowance information is set to have the highest importance. Since the requirement corresponding to the user priority information dynamically determines a priority depending on the importance of traffic of data that a current station attempts to transmit, the user priority information is set to have a medium importance. In case of the station hardware identifier information, since distribution of a MAC address of each station is random, the station hardware identifier information is set to have the lowest importance for control of approach to an unspecific station.

To be more specific, firstly, it is assumed that DILS information of a communication configuration message transmitted by an AP includes all the vendor-specific access allowance information, the user priority information, and the station hardware identifier information. If a station receiving the message first meets the requirement for the vendor specific access allowance information, it attempts an access to the AP without considering whether it meets the other requirements. If the station does not meet the requirement for the vendor-specific access allowance information, it attempts an access when it meets the requirements for the user priority information and the station hardware identifier information. Exceptionally, however, if the user priority is a specific level or higher, the station may attempt an access to the AP, irrespective of whether it meets the requirement for the station hardware identifier information.

Secondly, it is assumed that DILS information of a communication configuration message transmitted by an AP includes the user priority information and the station hardware identifier information. If a station receiving the message meets the requirements for both the user priority information and the station hardware identifier information, it attempts an access. Exceptionally, however, if the user priority is a specific level or higher, the station may attempt an access to the AP, irrespective of whether it meets the requirement for the station hardware identifier information.

Thirdly, it is assumed that DILS information of a communication configuration message transmitted by an AP includes only the vendor-specific access allowance information and the user priority information, or only the vendor-specific access allowance information and the station hardware identifier information. If a station receiving the message first meets the requirement for the vendor-specific access allowance information, it attempts an access to the AP without considering whether it meets the other requirements. If the station does not meet the requirement for the vendor-specific access allowance information, it attempts an access when it meets the requirement for the user priority information or the station hardware identifier information.

Fourthly, it is assumed that DILS information of a communication configuration message transmitted by an AP includes only one of the vendor-specific access allowance information, the user priority information and the station hardware identifier information. If a station receiving the message meets the requirement for the information included in the DILS information, it attempts an access to the AP.

As described above, the combine state and the priority of the requirements included in the DILS information may be variously set, and this information may be discriminated through the link setup information.

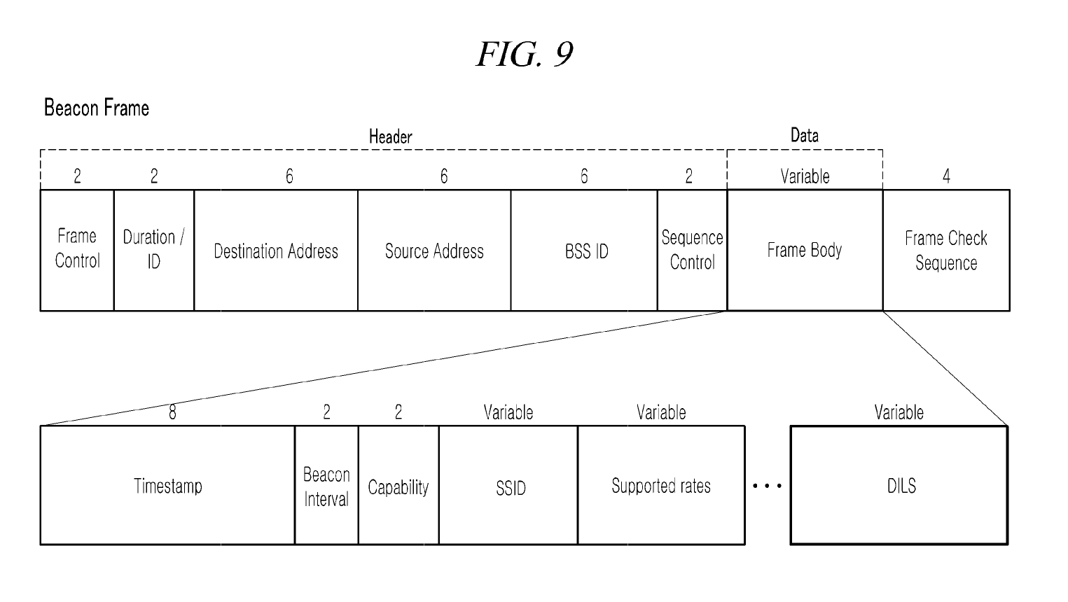

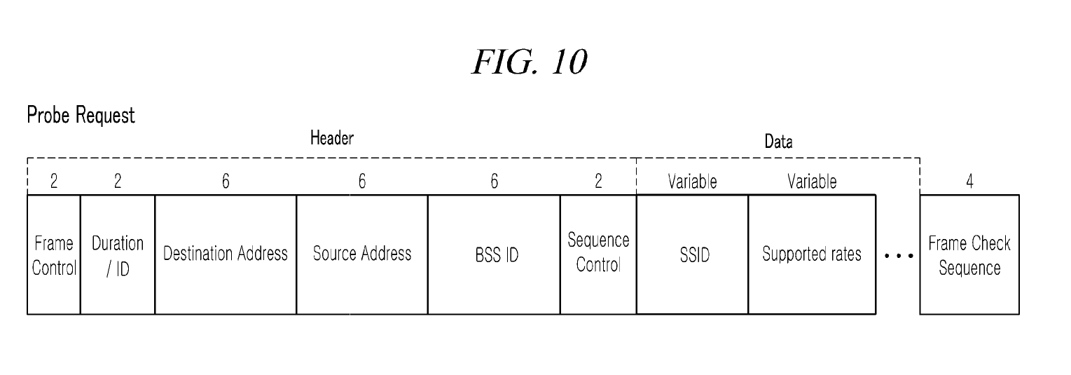

FIG. 9 shows a structure of a beacon message periodically transmitted to STAs by an AP in accordance with an exemplary embodiment.

If an AP provides differentiated link setups to STAs, access priority requirement information is inserted into a data field of the beacon message. STAs attempting an access to the corresponding AP may analyze the access priority requirement included in the DILS information, particularly, the initial link setup category information, to attempt the access within an available access time after receiving the beacon if they meet the corresponding requirement, or attempt the access after the available access time if they do not meet the corresponding requirement.

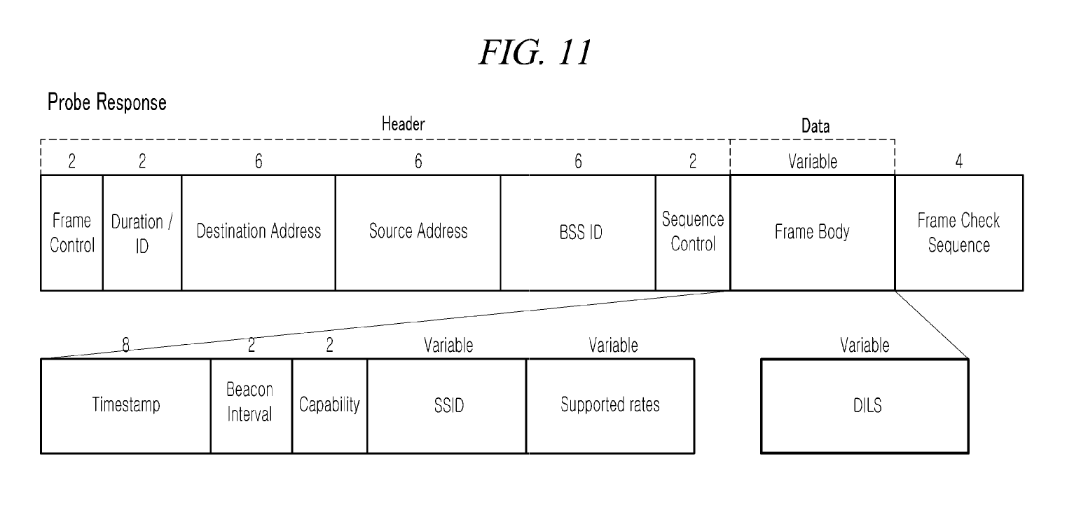

FIG. 10 shows a structure of a probe request message that requests an access to an AP in order for STAs to access the AP, and FIG. 11 shows a structure of a probe response message transmitted by an AP having received a probe request message in accordance with an exemplary embodiment.

If an AP provides differentiated link setups to STAs, access priority requirement information is inserted into a data field of the probe response message. The STAs attempting an access to the corresponding AP may analyze the access priority requirement included in the DILS information, particularly, the initial link setup category information, to attempt the access within an available access time after receiving the beacon if they meet the corresponding requirement, or attempt the access after the available access time if they do not meet the requirement.

As described above, the communication configuration message like the beacon message in the passive scanning manner or the probe response message in the active scanning manner includes information on an access priority requirement for each station, and on this basis, each station implements an access configuration.

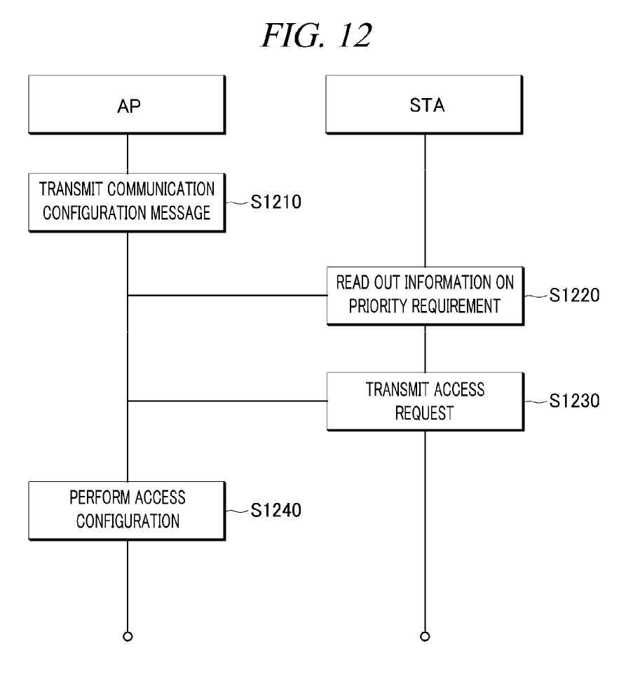

FIG. 12 is a flowchart illustrating a process of an access between an STA and an AP in accordance with an exemplary embodiment.

Firstly, an AP transmits a communication configuration message to an STA (S1210). For example, in case of the passive scanning manner, the beacon message is the communication configuration message. In case of the active scanning manner, the probe response message is the communication configuration message. In addition, as described above, the communication configuration message includes the DILS information, i.e., information on an access priority requirement for an STA.

Then, the STA reads out the information on the access priority requirement included in the communication configuration message (S1220). In this case, the information on the access priority requirement includes information of time, for which a station meeting the access priority requirement can attempt an access. Further, the information on the access priority requirement may include information indicative of a user priority, information indicative of a hardware identifier of a station allowable for access, and information indicative of a requirement for a station allowable for access, which is defined by vendors. In addition, the information on the access priority requirement may include information indicative of a combined state of the information or a priority of the information.

Then, the STA transmits an access request to the AP on the basis of on the read-out information (S1230). Since STAs meeting the access priority requirement included in the communication configuration message are different from one another, they transmit their access requests at different time points.

Then, the AP implements an access configuration with the STA that has implemented the access request (S1240).

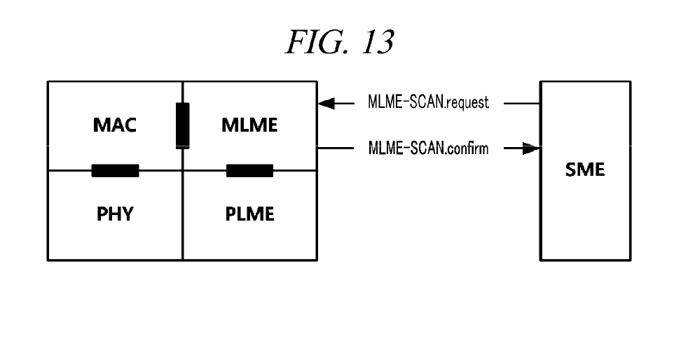

FIG. 13 shows an internal layer structure of a STA in accordance with an exemplary embodiment.

Layers defined in the IEEE 802.11 standard largely include a medium access control (MAC) layer and a physical (PHY) layer. A mac layer management entity (MLME) and a physical layer management entity (PLME) are configured to manage each of the layers, and the entities receive instructions from a station management entity (SME) managing STAs.

Hereinafter, a process, in which an STA searches an AP on the basis of the internal layer structure of the STA, will be described. The SME transmits a MLME scan request primitive (MLME-SCAN.request primitive) to the MLME. The MLME scan request primitive includes conditions or information for channel search. The MLME having received the primitive implements the passive or active scanning described in FIG. 6 and FIG. 7 according to the conditions specified in the primitive.

Meanwhile, a reporting option may be defined such that when receiving the beacon message or the probe response message from a specific AP, the PHY and MAC layers process information, and when finding out BSS information, the information is reported to the SME.

In this case, the reporting option is classified into immediate reporting (IMMEDIATE), channel specific reporting (CHANNEL_SPECIFIC), and at-end reporting (AT END).

Firstly, if the reporting option is the immediate reporting, BSS information is transmitted to the SME through the MLME scan confirmation primitive (MLME-SCAN.confirm primitive) immediately when the BSS information is found out.

Secondly, if the reporting option is the channel reporting, one or more BSS information found out in a certain channel is transmitted to the SME through the MLME scan confirmation primitive (MLME-SCAN.confirm primitive) at once after lapse of a maximum channel time (MaxChannelTime) from the time when the scanning starts.

Thirdly, if the reporting option is the at-end reporting, all BSS information found out in one or more channels are transmitted to the SME through the MLME scan confirmation primitive (MLME-SCAN.confirm primitive) at once at the time when the scanning for all the channels is terminated.

For example, thirteen (13) channels may exist in 2.4 GHz wireless LAN, and a certain AP operates in a certain channel. Since an STA does not know in which channels APs are present, it sequentially or randomly implements scanning by channels. In this case, if the reporting option is the immediate reporting, found AP information is immediately and internally reported to the STA. If the reporting option is the reporting by channels, information of all APs found out in one channel is reported at once at the time when the corresponding channel is terminated. In addition, if the reporting option is the at-end reporting, information of all APs found out in all channels is reported only once at the final time point.

In accordance with an exemplary embodiment, even if the reporting option of the MLME scan request primitive is the immediate reporting (Reporting Option=IMMEDIATE) and the MLME implements passive or active scanning through the corresponding primitive, it is possible to delay a transfer BSS information, to the SME, extracted from the beacon message or the probe response message, which includes DILS information having the LSB bit set to 1. Instead, the BSS information may be transferred to the SME after being delayed until the time when scanning of the corresponding channel or all channels is terminated. This is intended to determine that other STAs' requests for access to the AP having transmitted the corresponding communication configuration message are relatively high and delay the requests for access to the corresponding AP.

However, if the reporting option is the immediate reporting, BSS information extracted from the beacon message or the probe response message, which includes no DILS information or DILS information having the LSB bit set to zero (0), is immediately transferred to the SME according to the immediate reporting. In this way, the SME may preferentially process the information on the AP having no DILS information. In addition, if it is determined that other STAs' requests for access to the AP having transmitted the corresponding communication configuration message are relatively low, the transmission is implemented according to the initially set reporting option.

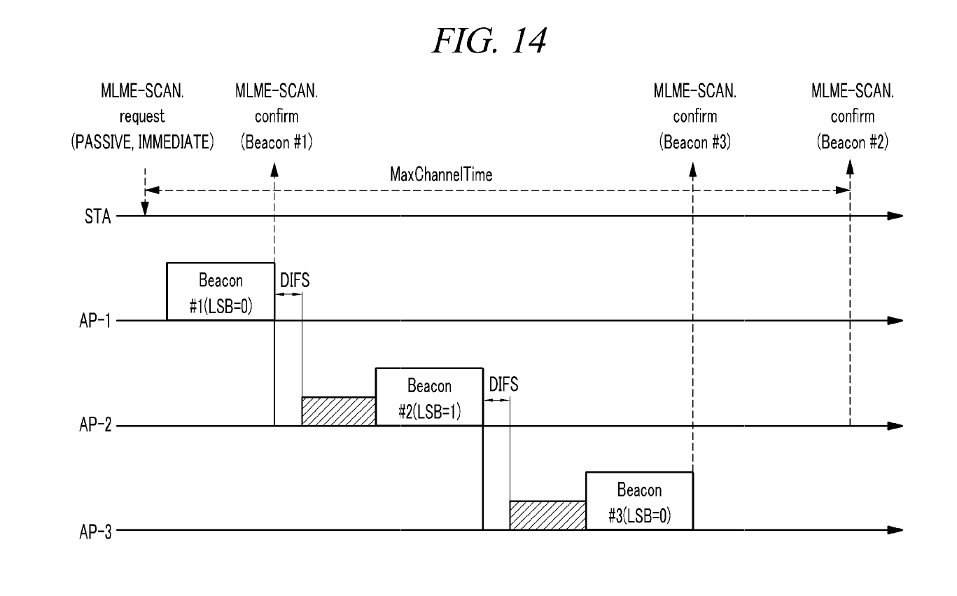

FIG. 14 illustrates a passive scanning process in accordance with an exemplary embodiment. The SME transfers instructions to the MLME by setting the scan type in the MLME scan request primitive to passive (Scan Type=PASSIVE) and the reporting option to the immediate reporting (Reporting Option=IMMEDIATE). When a certain channel receives transmission of the beacon message for a minimum channel time (MinChannelTime) from the time when the instructions are transferred, the STA collects the beacon messages for the maximum channel time (MaxChannelTime).

According to FIG. 14, the STA receives the beacon message from each of AP-1, A-2, and A-3. In this case, it is assumed that the LSB bit in the DILS information of the beacon message received from each of the AP-1 and the AP-3 is set to zero (0), and the LSB bit of the beacon message received from the AP-2 is set to 1. This indicates a state where the AP-2 is currently receiving access requests (Authentication Request or Association Request) from many STAs. In this case, in case of the beacon messages received from the AP-1 and the AP-3, the STA immediately transfers the BSS information received in the beacon messages through the MLME scan confirmation primitive according to the immediate reporting option, which is the reporting option requested upon the MLME scan request. However, in case of the beacon message received from the AP-2, the STA does not follow the immediate reporting option and transfers the BSS information received in the beacon message to the SME after delaying the transfer until the time when scanning of the corresponding channel or all channels is terminated. FIG. 14 illustrates an example for transferring the BSS information, which is included in the beacon message received from the AP-2 and has the LSB bit set to 1, to the SME after delaying the transfer until the time when scanning of the corresponding channel is terminated. This is intended to determine that other STAs' requests for access to the AP having transmitted the corresponding communication configuration message are relatively high and delay the requests for access to the corresponding AP.

In accordance with still another exemplary embodiment, there are methods capable of delaying and transferring the beacon message having the LSB bit set to 1 to the SME or deferring the transfer, compared to other beacon messages having the LSB bit set to zero (0) or including no DILS information. This determination may be determined by a relative difference between the number of the beacon messages having the LSB bit set to zero (0) or including no DILS information, and the number of the beacon messages having the LSB bit set to 1.

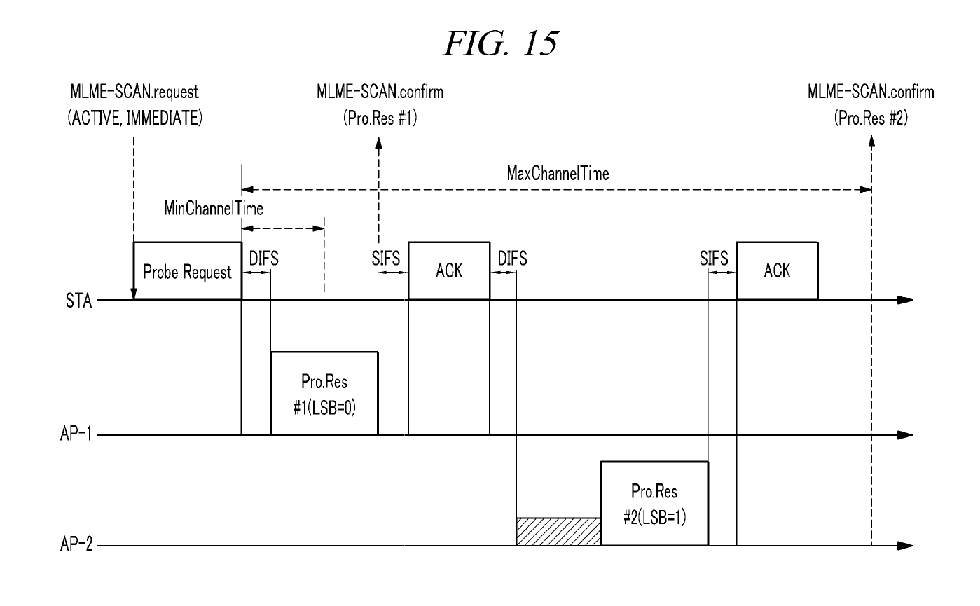

FIG. 15 illustrates an active scanning process in accordance with an exemplary embodiment.

The SME within the STA transfers instructions to the MLME by setting the scan type in the MLME scan request primitive to active (Scan type=ACTIVE) and the reporting option to immediate reporting (Reporting Option=IMMEDIATE). When a certain channel receives transmission of a probe response message for the minimum channel time (MinChannelTime) from the time when the probe request messages is transmitted, the STA collects the probe response messages for the maximum channel time (MaxChannelTime).

According to FIG. 15, the STA receives the probe response message from each of the AP-1 and the AP-2, and in this case, it is assumed that the LSB bit of the DILS information in the probe response message received from the AP-1 is set to zero (0), and the LSB bit of the probe response message received from the AP-2 is set to 1. This indicates a state where the AP-2 is currently receiving access requests (Authentication Request or Association Request) from many STAs. Here, in case of the probe response message received from the AP-1, the STA immediately transfers the BSS information received in the probe response message to the SME through the MLME scan confirmation primitive according to the immediate reporting option, which is the reporting option requested upon the MLME scan request. However, in case of the probe response message received from the AP-2, the STA does not follow the immediate reporting option and transfers the BSS information received in the probe response message to the SME after delaying the transfer until the time when scanning of the corresponding channel or all the channels is terminated. FIG. 15 illustrates an example for transferring the BSS information, which is included in the probe response message received from the AP-2 and having the LSB bit set to 1, to the SME after delaying the transfer until the time when scanning of the corresponding channel is terminated. This is intended to determine that other STAs' requests for access to the AP having transmitted the corresponding communication configuration message are relatively high and delay the requests for access to the corresponding AP.

In accordance with still another exemplary embodiment, there are methods capable of delaying and transferring the probe response message having the LSB bit set to 1 to the SME or deferring the transfer, compared to other probe response messages having the LSB bit set to zero (0) or including no DILS information. This determination may be determined by a relative difference between the number of the probe response messages having the LSB bit set to zero (0) or including no DILS information and the number of the probe response messages having the LSB bit set to 1.

In accordance with still another example embodiment, the instructions are transferred by setting the scan type in the MLME scan request primitive to active or passive, and the reporting option to reporting by channels. In this case, the communication configuration message having the LSB bit set to 1 is delayed and transferred to the SME, compared to other communication setup messages having the LSB bit set to zero (0) or including no DILS information. In this case, the relevant information is set to be transmitted according to the at-end reporting option, which further delays the reporting timing, compared to the reporting option by channels. However, in case of the communication configuration message including no DILS information or having the LSB bit set to zero (0), the relevant information is transmitted according to the previously set reporting option by channels.

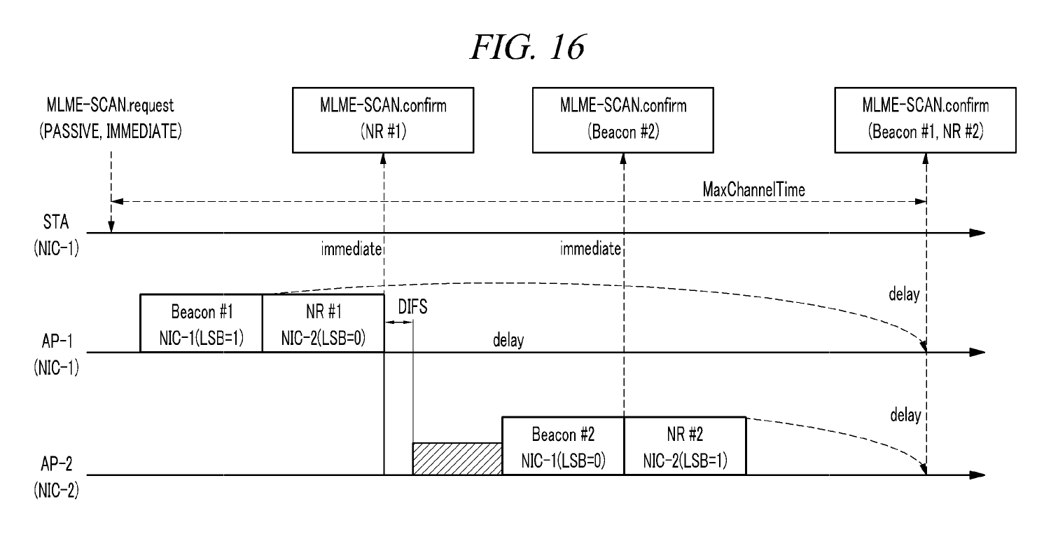

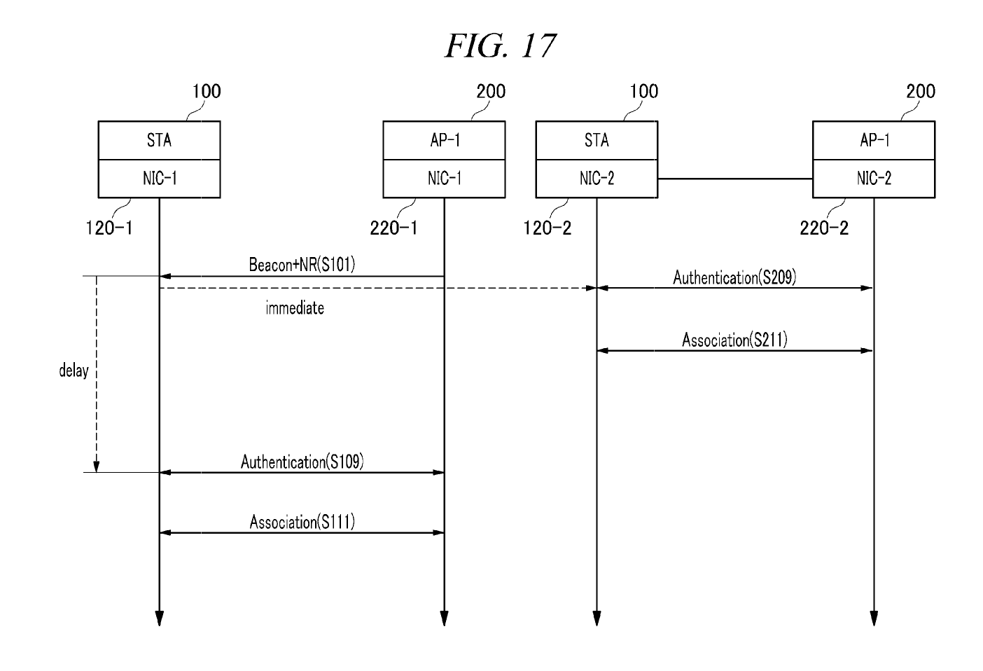

FIG. 16 shows a process of scanning between an AP and a STA each including multiple network interface card modules in accordance with an exemplary embodiment, and FIG. 17 shows a process of an access between an AP and a STA in accordance with an exemplary embodiment.

The illustrated exemplary embodiments show that an AP is provided with multiple network interface card modules, whereby an STA implements an access in consideration of access priority requirements by the network interface card modules.

The SME within the STA transfers instructions to the MLME by setting the scan type in the MLME scan request primitive to passive (Scan Type=PASSIVE), and the reporting option to immediate reporting (Reporting Option=IMMEDIATE). When a certain channel receives transmission of the beacon message by using the network interface card modules for the minimum channel time (MinChannelTime) from the time when the instructions are transferred, the STA collects the beacon messages for the maximum channel time (MaxChannelTime).

The STA receives the beacon message from each of the AP-1 and the AP-2, and in this case, it is assumed that each of the AP-1 and the AP-2 has two (2) network interface card modules. The communication configuration message transmitted by the AP-1 includes a first beacon message (Beacon #1) including information on BSS operated in the first network interface card module 220_1 of the AP-1 and a first neighbor report (NR #1) including information on BSS operated in a second network interface card module 220_2 of the AP-1. That is, the first beacon message and the first neighbor report are transmitted in a combined form.

In this case, it is assumed that the LSB bit within the DILS information of the first beacon message is set to 1 and the LSB bit within the DILS information of the first neighbor report message is set to zero (0). This indicates a state where the first network interface card module 220_1 of the AP-1 is currently receiving access requests (Authentication Request or Association Request) from many STAs and the second network interface card module 220_2 of the AP-1 offers a smooth access.

The communication configuration message transmitted by the AP-2 includes a second beacon message (Beacon #2) including information on BSS operated in the first network interface card module of the AP-1 and a second neighbor report (NR#2) including information on BSS operated in the second network interface card module of the AP-2.

In this case, it is assumed that the LSB bit within the DILS information of the second beacon message is set to zero (0) and the LSB bit within the DILS information of the second neighbor report message is set to 1. This indicates a state where the first network interface card module of the AP-2 offers a smooth access and the second network interface card module of the AP-2 is currently receiving access requests (Authentication Request or Association Request) from many STAs.

Here, in case of the first neighbor report message and the second beacon message received from the AP-1 and the AP-2, the STA immediately transfers the BSS information received from the AP-1 and the AP-2 to the SME through the MLME scan confirmation primitive according to the immediate reporting option, which is the reporting option requested upon the MLME scan request. However, in case of the first beacon message and the second neighbor report, the STA does not follow the immediate reporting option and transfers the BSS information after delaying the transfer until the time when scanning of the corresponding channel or all channels is terminated. FIG. 16 illustrates an example for transferring the BSS information included in the message having the LSB bit set to 1 to the SME after delaying the transfer until the time when scanning of the corresponding channel is terminated. This is intended to determine that other STAs' requests for access to the AP having transmitted the corresponding communication configuration message are relatively high and delay the requests for access to the corresponding AP.

In accordance with still another exemplary embodiment, there are methods capable of delaying and transferring a beacon (or neighbor report) message having the LSB bit set to 1 to the SME or deferring the delay, compared to other beacon (or neighbor report) messages having the LSB bit set to zero (0) or including no DILS information. This determination may be determined by a relative difference between the number of the beacon (or neighbor report) messages having the LSB bit set to zero (0) or including no DILS information and the number of the beacon (or neighbor report) messages having the LSB bit set to 1.

FIG. 17 shows a process of an access between a STA and an AP in accordance with an exemplary embodiment.

As illustrated, the STA 100 has multiple network interface card modules 120_1 and 120_2 and the AP-1 200 has multiple network interface card modules 220_1 and 220_2. More specifically, FIG. 17 illustrates a case where the STA 100 accesses the multiple network interface card modules 220_1, 220_2 of the AP-1 200 by using both the multiple network interface card modules 120_1 and 120_2 at the same time.

In a case where the STA 100 attempts a wireless LAN access, firstly, the AP-1 200 periodically transmits a beacon message to STAs existing within service areas of all BSSs operated by the AP-1 200 through a broadcast method (S101). In the present exemplary embodiment, it is assumed that the AP-1 200 transmits the beacon message through the first network interface card module 220_1 (S101).

In the present exemplary embodiment, when the STA 100 receives a communication configuration message through the first network interface card module 120_1, the corresponding message may include a beacon message and a neighbor report message. The beacon message includes information of BSS operated by the AP-1 200 through the first network interface card module 220_1. The neighbor report message includes information of BSS of the second network interface card module 220_2 operated by the AP-1 200.

The STA 100 having received the communication configuration message may delay reporting of the BSS information included in each of the messages on the basis of values for the LSB bit of the DILS information included in the beacon message and the neighbor report. Since the value for the LSB bit in the beacon message transmitted by the first network interface card module 220_1 of the AP-1 200 is set to 1, the reporting is delayed and thereafter, access processes (S109, S111) proceed.

Since the value for the LSB bit in the neighbor report transmitted by the second network interface card module 220_2 of the AP-1 200 is set to 0, the BSS information is immediately reported to the SME and thereafter, access processes (S209, S211) proceed.

As described above, the AP may transmit information on the access priority requirements by the multiple network interface card modules, and on this basis, the STA implements an access request for each of the network interface card modules.

The exemplary embodiments can be embodied in a storage medium including instruction codes executable by a computer or processor such as a program module executed by the computer or processor. A data structure in accordance with the exemplary embodiments can be stored in the storage medium executable by the computer or processor. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as a computer-readable instruction code, a data structure, a program module or other data. The communication medium typically includes the computer-readable instruction code, the data structure, the program module, or other data of a modulated data signal such as a carrier wave, or other transmission mechanism, and includes information transmission mediums.

The system and method of the present disclosure has been explained in relation to a specific embodiment, but its components or a part or all of its operations can be embodied by using a computer system having general-purpose hardware architecture.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. An access configuration method between an access point and a station, comprising:
receiving a communication configuration message transmitted from the access point by the station;
reading out information on a priority requirement of the station included in the communication configuration message; and
requesting an access to the access point according to the information on the priority requirement of the station.

2. The access configuration method of claim 1,
wherein the information on the access priority requirement includes information of time for which a station corresponding to the access priority requirement attempts an access.

3. The access configuration method of claim 1,
wherein the information on the access priority requirement includes one or more of first information indicative of a user priority, second information indicative of a hardware identifier of a station allowable for access, and third information indicative of a requirement for a station allowable for access, which is defined by vendors.

4. The access configuration method of claim 3,
wherein the information on the access priority requirement includes fourth information indicative of a combined state of the first information, the second information, and the third information or a priority of the information.

5. The access configuration method of claim 3,
wherein the requesting for an access includes requesting an access when the first information matches with a priority of transmission target traffic of the station.

6. The access configuration method of claim 4,
wherein the requesting for an access includes determining whether a requirement included in the fourth information is satisfied and requesting an access depending on a result of the determination.

7. The access configuration method of claim 4,
wherein if the fourth information indicates that all the first to third information should be satisfied, the requesting for an access includes requesting an access only when all the corresponding requirements are satisfied.

8. The access configuration method of claim 4,
wherein if the fourth information indicates that requirements corresponding to one or more of the first to third information should be satisfied, the requesting for an access includes requesting an access even when only one of the requirements corresponding to one or more of the first to third information is satisfied.

9. The access configuration method of claim 4,
wherein if the fourth information indicates a sequence of priority from the third information and the first information to the second information, the requesting for an access includes requesting an access when a requirement corresponding to the third information is satisfied.

10. The access configuration method of claim 9,
wherein if the requirement corresponding to the third information is not satisfied, the requesting for an access further includes requesting an access when requirements corresponding to the first information and the second information are satisfied.

11. The access configuration method of claim 9,
wherein if the requirement corresponding to the third information is not satisfied, the requesting for an access further includes requesting an access when the first information is satisfied and user priority information included in the first information is equal to or higher than a threshold level.

12. The access configuration method of claim 4,
wherein if the fourth information indicates that requirements corresponding to the first information and the second information should be satisfied, the requesting for an access includes requesting an access when the requirements corresponding to the first information and the second information are satisfied.

13. The access configuration method of claim 12,
wherein if the requirements corresponding to the first information and the second information are not satisfied, the requesting for an access further includes requesting an access when the first information is satisfied and user priority information included in the first information is equal to or higher than a threshold level.

14. The access configuration method of claim 4,
wherein if the fourth information indicates that requirements corresponding to the third information and the second information or that requirements corresponding to the third information and the first information should be satisfied, the requesting for an access includes requesting an access when a requirement corresponding to the third information is satisfied.

15. The access configuration method of claim 14,
wherein if the requirement corresponding to the third information is not satisfied, the requesting for an access further includes requesting an access when a requirement corresponding to the second information or the first information is satisfied.

16. The access configuration method of claim 4,
wherein the fourth information indicates that requirements corresponding to the first information, the second information or the third information should be satisfied, the requesting for an access includes requesting an access when each requirement is satisfied.

17. The access configuration method of claim 1,
wherein the communication configuration message is a beacon message of the access point, or
a response message output by the access point in response to a request of the station.

18. A station device comprising:
a memory that stores a program for performing an access configuration with respect to an access point;
one or more communication interface cards; and
a processor that executes the program stored in the memory,
wherein when the program is executed, the processor receives a communication configuration message transmitted from the access point, reads out information on a priority requirement of a station included in the communication configuration message, and requests an access to the access point according to the information on the priority requirement of the station.

19. The station device of claim 18,
wherein the information on the access priority requirement includes information of time for which a station corresponding to the access priority requirement attempts an access.

20. The station device of claim 18,
wherein the information on the access priority requirement includes one or more of first information indicative of a user priority, second information indicative of a hardware identifier of a station allowable for access, and third information indicative of a requirement for a station allowable for access, which is defined by vendors.

21. The station device of claim 20,
wherein the information on the access priority requirement includes fourth information indicative of a combined state of the first information, the second information, and the third information or a priority of the information.
